(19) United States
(12) Patent Application Publication
(10) Pub. No.: US 2011/0078611 A1
(43) Pub. Date: Mar. 31, 2011

(54) METHOD AND APPARATUS FOR THE ACCESS TO COMMUNICATION AND/OR TO WRITING USING A DEDICATED INTERFACE AND A SCANNING CONTROL WITH ADVANCED VISUAL FEEDBACK

(76) Inventors: Marco Caligari, Cressa (IT); Paolo Invernizzi, Milano (IT); Franco Martegani, Mozzate (IT)

(21) Appl. No.: 12/993,911

(22) PCT Filed: May 22, 2009
(86) PCT No.: PCT/IB09/52146

§ 371 Date: Nov. 22, 2010

(51) Int. Cl. G06F 3/048

(52) U.S. Cl. 715/771

(57) ABSTRACT

The method and the apparatus of the present invention is related to a system to access to communication and/or to writing using means as personal computer, and it is targeted particularly to disabled people suffering heavy restriction of their organisation and execution of movements. A heavy motor disability means the impossibility to use the traditional devices as computer peripheral command devices, and, being impossible to perform direct selection of items on the screen in order to give commands, it is necessary to use a scanning technique. This technique provides the possibility to use one or more external sensors to select the command on a matrix of letters or symbols that are displayed in succession. The process of interaction between disabled user and machine has been made easier using a visual feedback that provides the user to foresee the path of scanning. In this way the scanning method is determined in advance and the cognitive effort carried out by the user is considerably reduced.

### FIELD OF THE INVENTION

The present invention is related to techniques of access to communication and/or writing using high-tech devices, as computer, for disabled users having severe restriction of movement organization or having only one controlled movement. Being not able to use the traditional devices as command device for computer, the user must use the scanning technique to select the command on a matrix of letters or symbols that are displayed in temporal succession with one or more external sensors and with some artifices useful to decrease the cognitive effort.

### STATE OF THE ART

During last years the need of devices to access the communication and/or writing for disabled people, has aided the development of information solutions to make easier the access to high tech devices as the computer.

In fact, the extraordinary development of information technology and communication, has driven the development of a new class of devices, based on information technology, that have opened possibilities before unimaginable for people with motor, sensory and cognitive deficit.

The so called “Assistive Technology”, has the purpose to enlarge the capability to think, to inquire, to express oneself, to establish and keep a contact with the outside world, speeding up the communication and the interaction of people with motor, sensory, communicative or cognitive deficit.

Keyboards and special mouse, system of synthesis and vocal recognition, scanning programs, are born to replace input systems (mouse and keyboard) and output standard systems (monitor), adjusting the computer to people with problems. So, also for people with severe motor deficit, it is possible to work, study, maintain relations at distance, in a few words exit from loneliness (isolation) and think in positive way the life prospect.

In the actual state of the art, all software applications as aid to the severe motor deficit, are based on emulation of pointer movement with the purpose to place it on the desired item.

The limit of these systems is the impossibility to know “a priori” the needs of the user and particularly the impossibility to know the items with the user can interact.

If there are residual movements, also if very low, using a command sensor that notices the movement available, it is possible carried out a scanning (in sequence of steps) of the visible area on the screen (highlighting anyway areas of no interest, with consequent loss of time), till to identify the item selected.

Such scanning systems are flexible but, in general, also slow and tiring. In particular, in writing case, the operations described are slow and quite disappointing; for that reason have been studied tricks to restrict that problem, trying to return writing words or commands more fast and efficient, and trying to minimize the number of sensor selection. In these case nevertheless, from linear scanning to other types, the complexity of use increases. In fact, the variable matrix and the method of scanning row/column increase the speed, but involve a greater control of whole system, also from the cognitive point of view.

In other words, the user must think what he wants to do, but also he must be concentrated on how to do it: the use of scanning method is an additional task respect to the general task.

The system described following has the purpose to make easier the interaction process between disabled user and machine using a visual feedback that allows the user to foresee in advance the scanning path, and not to emulate the moving step of the cursor (that is replace the user in the pointer positioning on the selected item).

In that way, the scanning path is defined powerfully in advance and the memorization effort that the user must accomplish and the consequent error probability, are reduced considerably.

Besides, while, in general, the no linear scanning increases the speed, but involves a greater cognitive effort for the user, using this method the scanning can be also no linear, for example highlighting first the item more probable for the selection, without increasing in considerable manner the cognitive effort of the user.

The use of scanning isn't an additional task and the user must think just what he wants to do without too much concentration on how to do it.

### BRIEF DESCRIPTION OF THE FIGURES

FIG. 1 Shows a block diagram of the architecture of the method according to the present invention.

FIG. 2 Shows the flow chart of the method according to the present invention.

FIG. 3 Shows the flow chart related to the module of Command Execution.

FIG. 4 Shows the flow chart related to the scanning process according to the method of the present invention.

FIG. 5-6 Show an example of possible visual layout of feedback related to two method of scanning.

FIG. 7-11 Show as example the sequence of step to enter into the Mail Module of the application and open an e-mail message using a second method of visual feedback.

### DETAILED DESCRIPTION OF THE INVENTION

In a preferred embodiment of the present invention, the apparatus object of the present invention includes means of data and information processing, means of storage of said data and information, means of user interfacing and command sensors that people with severe motor deficit or also only one residual movement can use.

Said means of electronic processing of data and information comprise an appropriate control section, preferably based on at least a microprocessor and adapted to be implemented with a personal computer.

Said means of storage include preferably hard disk and flash memory.

Said means of user interface include means of data visualization, like displays, monitors or similar external output unit.

Said command sensors comprise devices (like buttons, pressure sensors, deformation sensors, puff sensor, myoelectric sensors, photoelectric sensors) that detect and process the movements available, even the smallest, to provide the confirm action during the interface scanning.

Said at least a microprocessor is preferably equipped with an appropriate software program including a set of application modules, comprising a set of instructions related to the performing of a function or of a group of functions. Through these modules the disabled user can communicate his thoughts and needs, can listen to reading texts and documents, can access to e-mails and write documents, surf the internet and access to contents and information, control the house appliances via home automation systems, access to telecommunication services (landlines or mobile phone, sms, mms) and to entertainment services (Video and Music player, Radio/TV), etc.

The selection of commands and functions occurs with scanning procedure that allows to locate and select an item belonging to a set of items through a sequence of choices performed among subsets of smaller and smaller size with respect to the starting set using a command sensor.

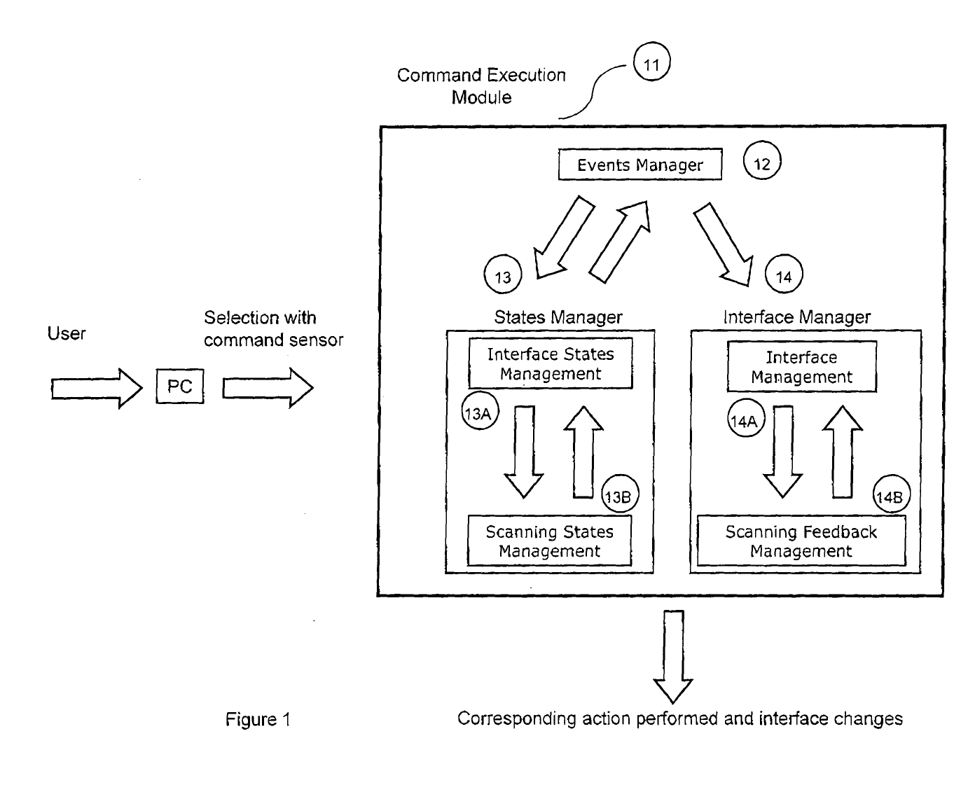

The architecture of such software program, described in FIG. 1, attached, includes the following modules: a module, so called, Command Execution 11, responsible of the software implemented method management, that decides the action to perform and carries it out. Said Command Execution module 11 holding the information related to the action type connected to activation of a certain component performed by the user.

Said module of Command Execution 11 includes three further modules: an Events Manager Module 12 that defines the rules to convert the input received from the user—through a sensor of command that detects the available movements—into a reply of the software application; a States Manager Module 13 that defines the state and the functionalities of the software application, and includes two further modules that interact with each other: the States Interface Management Module 13A and the Scanning States Management Module 13B, respectively responsible of definition of general states of the software application and of the states of the scanning process; an Interface Manager Module 14 adapted to manage the visualisation of the user interface items, comprising two further modules that interact with each other: the Interface Management Module 14A that defines the visualisation of general interface and the Scanning Feedback Management Module 14B that defines the method of visualisation of the feedback related to the scanning process.

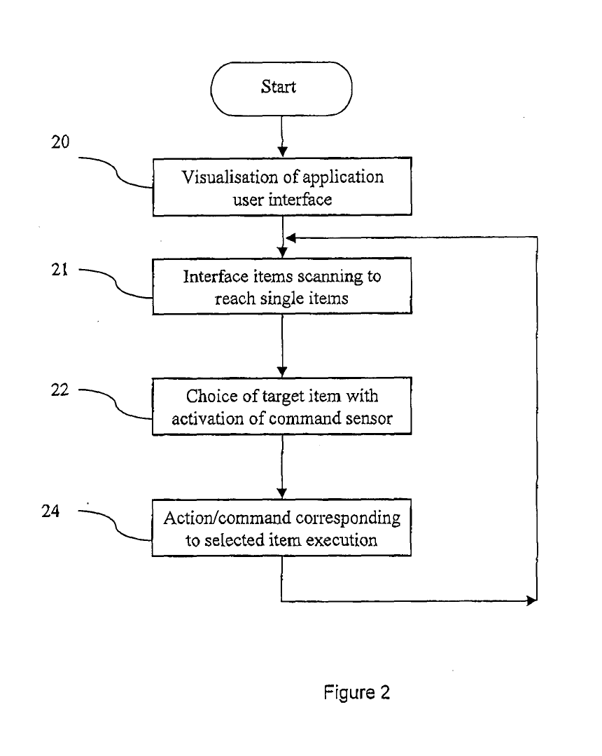

With reference to FIG. 2 the flow chart that shows the operation of the modules previously described and their mutual interactions is displayed together with the steps of the method according to the present invention.
a) The application user interface that allows the user to interact with said program is displayed 20, on the visualization means of the apparatus carrying out the method according to the present invention.
b) A scanning is performed 21 of the groups and sub-groups of elements displayed on said user interface, said groups and sub-groups comprising progressively a lower number of items at each step, said items being grouped in accordance with their position and/or function, until a single item group is reached.
c) The target item is selected 22 through activation of a command sensor associated to said apparatus.
d) The action corresponding to the selected item is carried out 23 and said user interface is changed accordingly.
e) The above sequence of steps recurs starting from step b) until it is terminated by an external command.

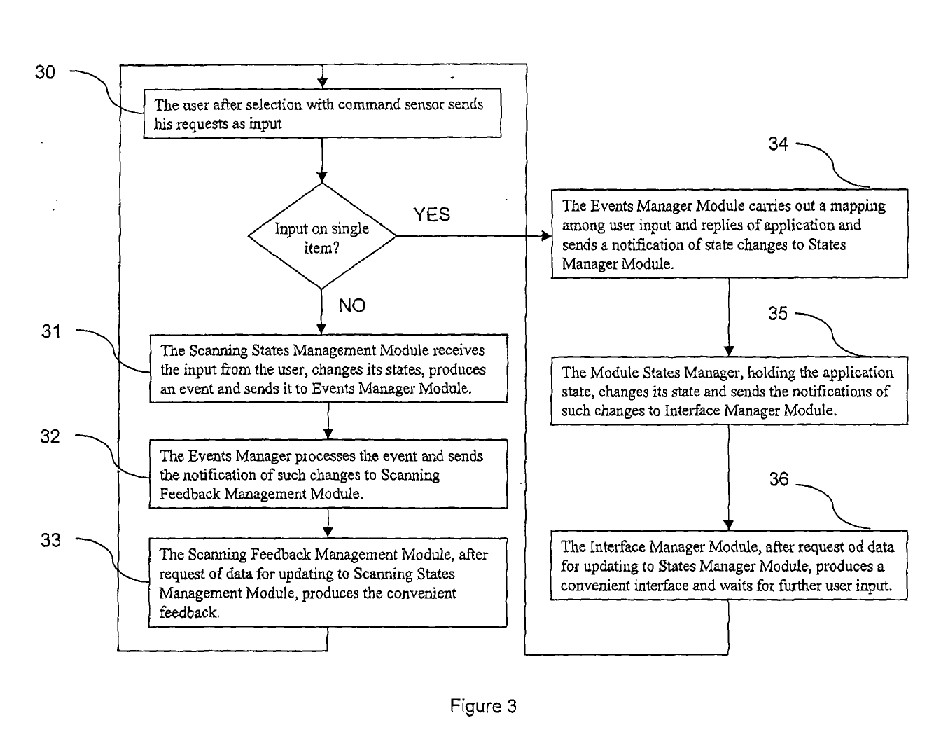

The scanning process of groups and subgroups according to the step b) of the sequence displayed in FIG. 2, is performed according to the following sequence as shown in FIG. 3:
f) The Scanning States Management Module receives input from the user, changes its state, produces an event and sends it 31 to the Events Manager Module.
g) The Events Manager Module processes the event received and sends 32 the notifications of such changes to the Scanning Feedback Management Module.
h) The Scanning Feedback Management Module, after request of data for update to Scanning States Management Module, produces 33 the suitable feedback and then waits for further input.

The step d) of the sequence shown in FIG. 2, corresponding to the execution of the action related to the selected item, is performed in accordance with the following sequence shown in FIG. 3:
i) The Events Manager Module carries out a mapping of user input and actions performed and sends 34 notifications of state changes to the States Manager Module.
j) The States Manager Module, holding the current state, changes its own state and sends 35 the notifications of such changes to the Interface Manager Module.
k) The Interface Manager Module, after requesting data for updating to the States Manager Module, generates 36 a suitable interface and waits for further user input.

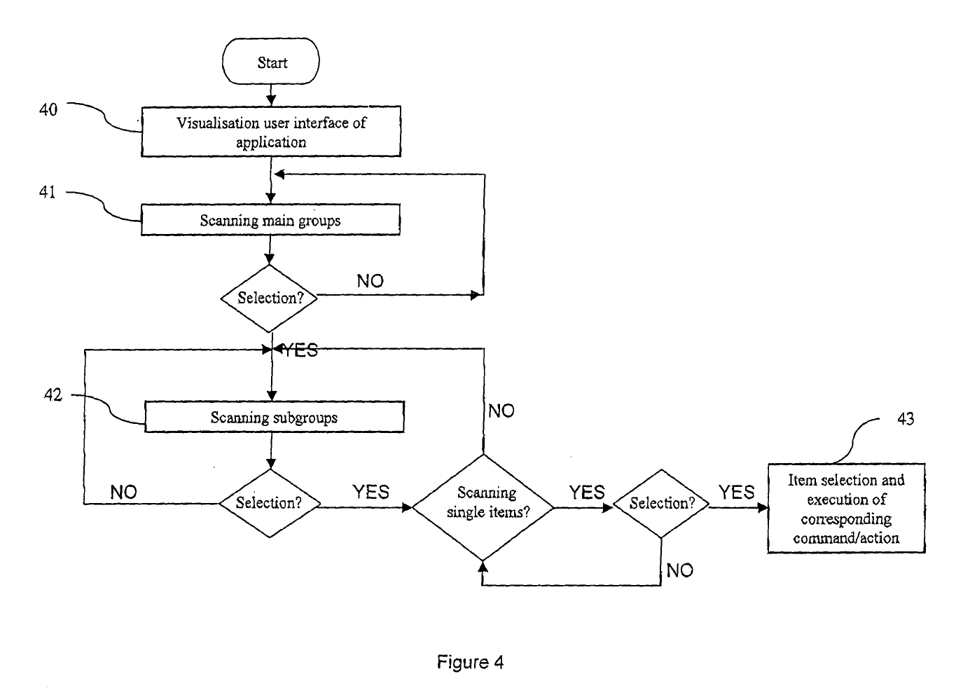

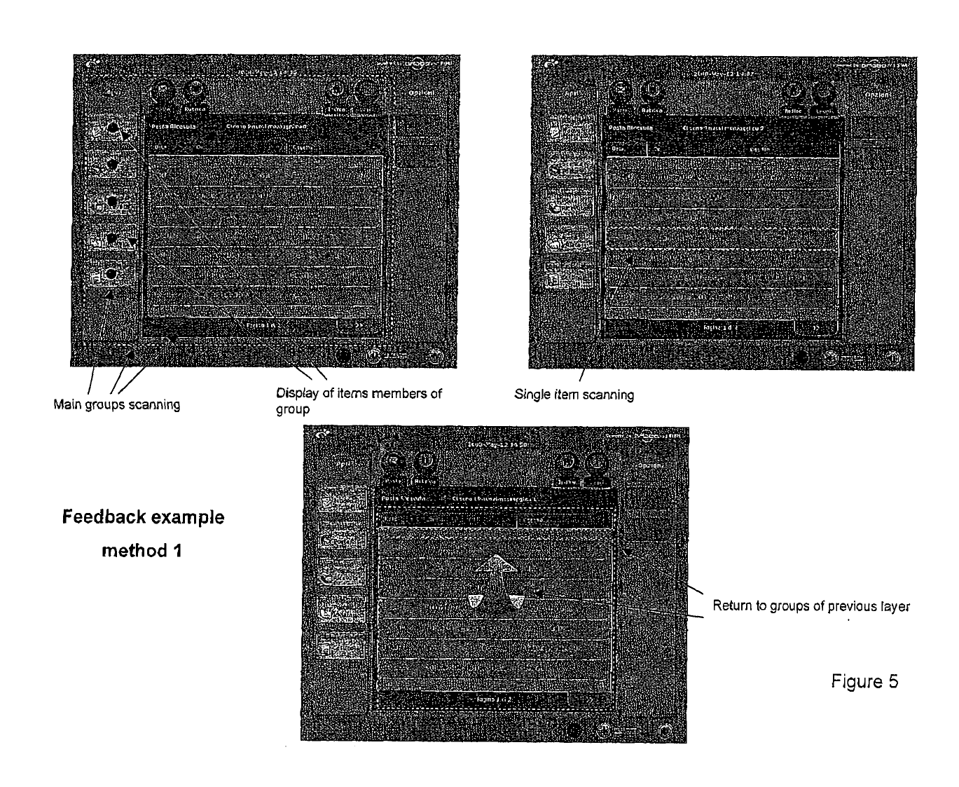

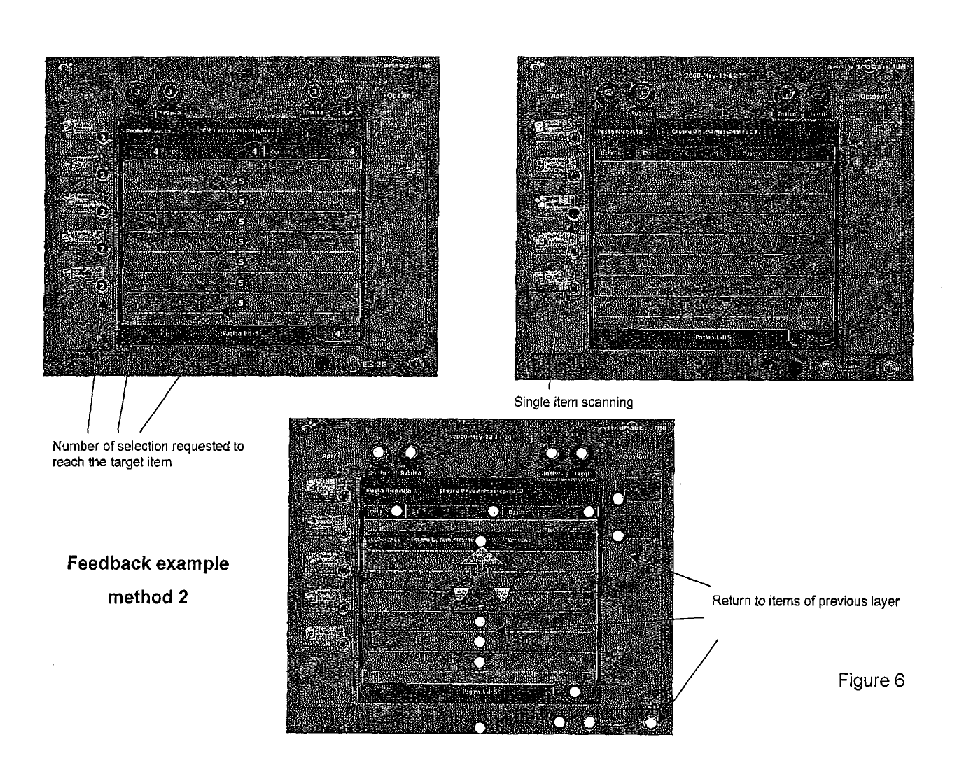

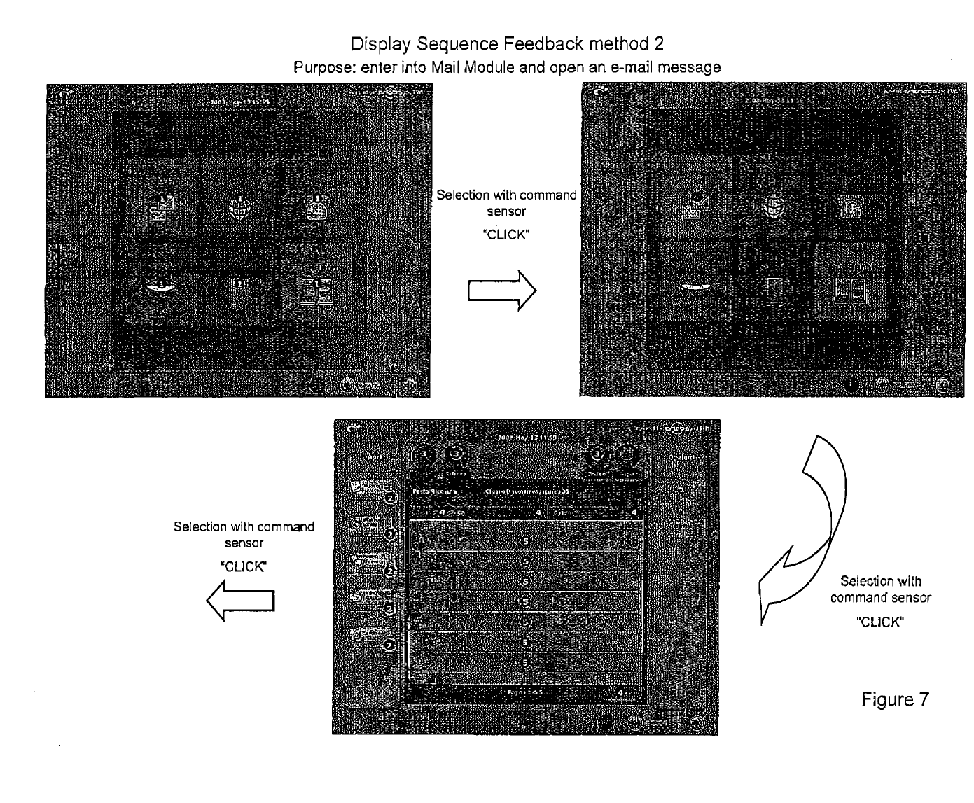

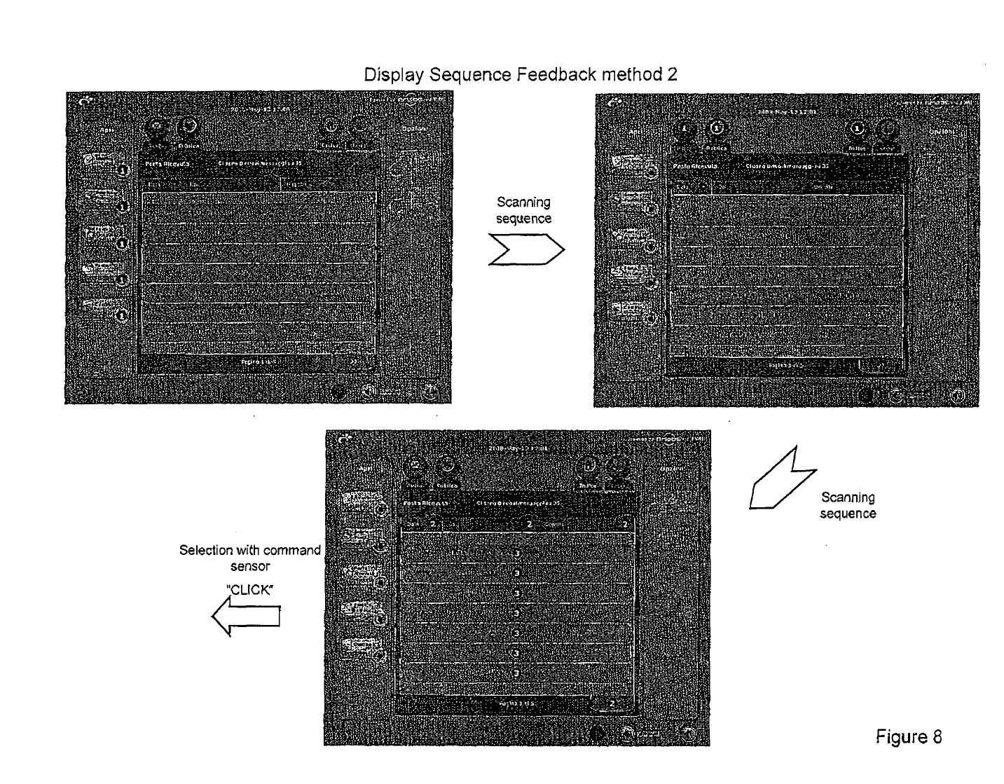

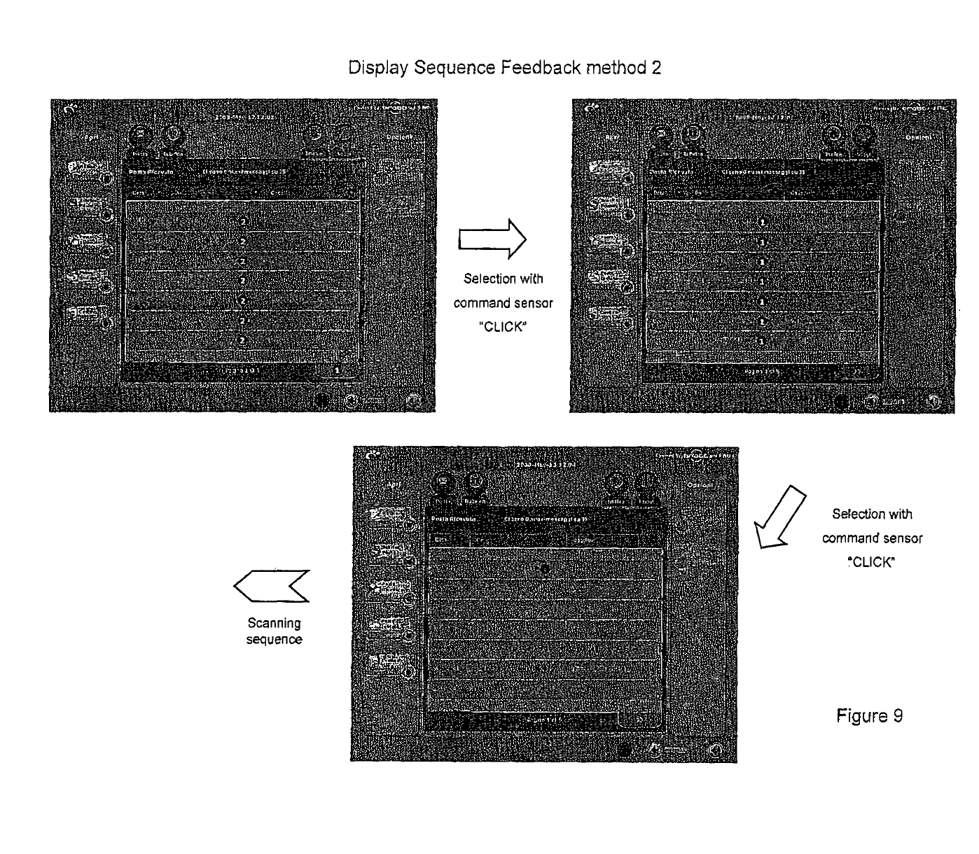

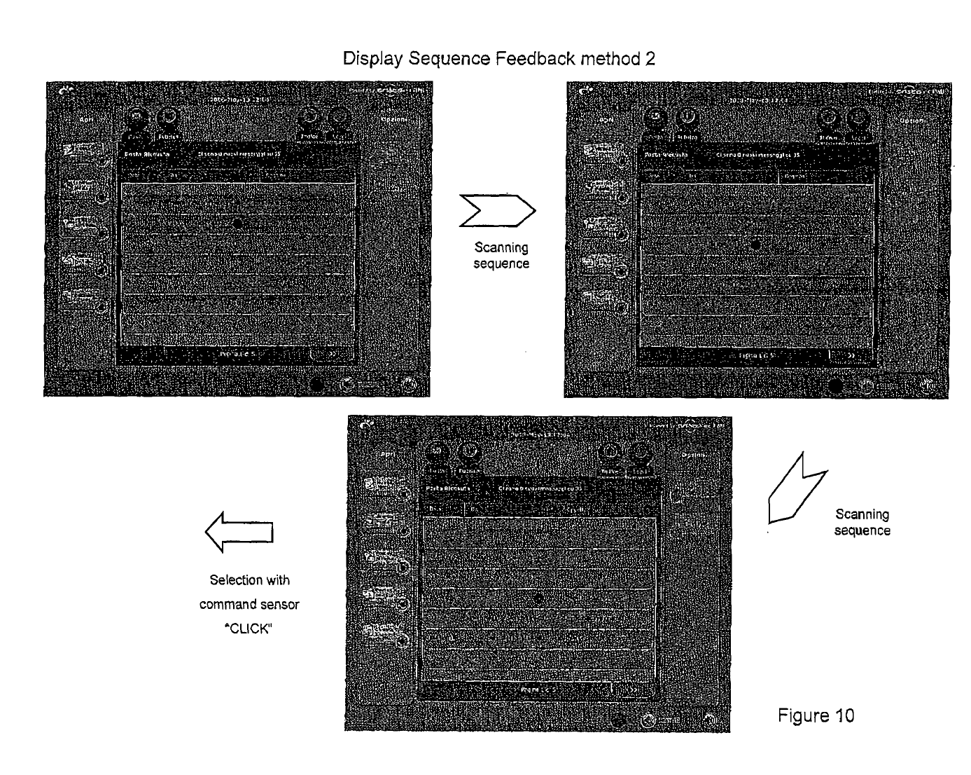

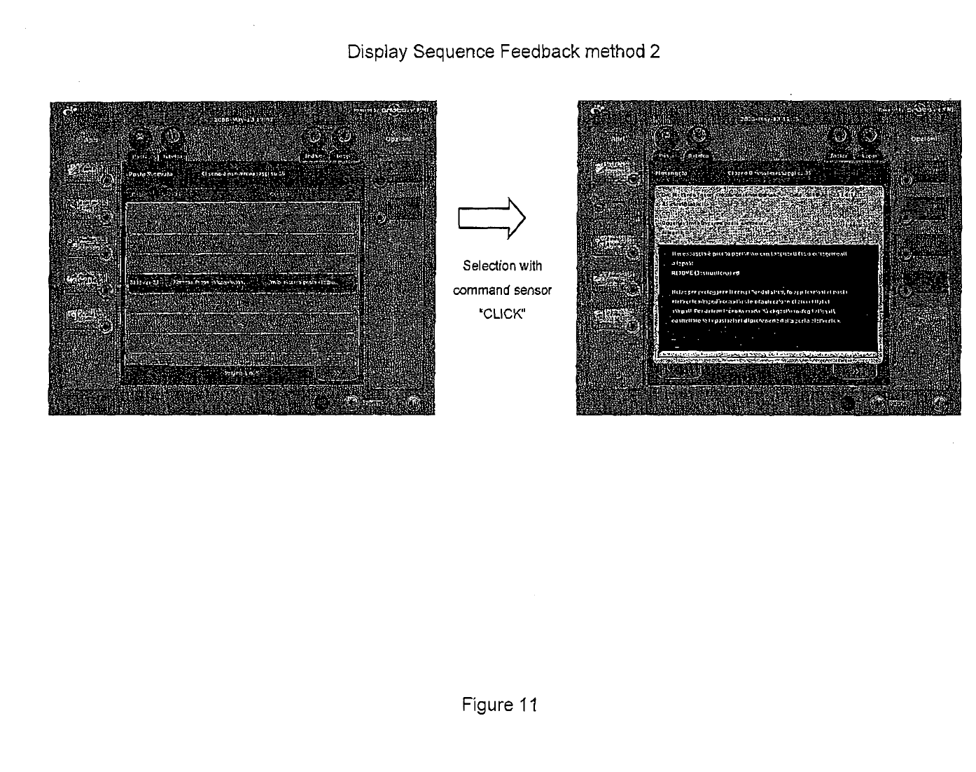

The sequence of scanning groups and subgroups down to the single items according to step b) and c) of the sequence described in FIG. 2, are performed in accordance with the sequence explained in the following and shown in FIG. 4:
l) The scanning of main groups is performed 41 until one of them is selected through the activation of a command sensor associated to said apparatus.
m) The scanning of subgroups is performed 42 until one of them is selected to reach single items, through the activation of a command sensor associated to said apparatus.
n) The scanning of single items is performed 43 until the target item is selected through the activation of a command sensor associated to said apparatus and the associated command/action is performed.

The scanning process of groups and subgroups down to the selection of the single items can be performed with several ways of visual feedback, all characterised by simpler interaction process between the disabled user and the machine using a visual feedback that allows the user to anticipate the scanning path.

Below, as an example, are described two different ways of visual feedback:

The first type of feedback provides that:
o) Suitable highlighting means are moved on said visualization means in accordance with predefined times and sequences highlighting said groups while the items belonging to said groups are highlighted using further highlighting means.
p) An icon that allows to step back to the previous group/subgroup is displayed on said visualization means during scanning process allowing to go back to the scanning of groups/subgroups of the previous level.
q) After the selection performed through command sensor, the scanning starts again from the subgroup which is currently highlighted by said suitable highlighting means, the items comprised thereby being highlighted by said further highlighting means.
r) The previous steps p) and o) are repeated until the single items are reached, the scanning of said single items proceeding in accordance with predefined times and sequences, highlighted by said suitable highlighting means.
s) Once the target item is selected a corresponding action is performed and the interface is updated accordingly, the scanning process will start again from the groups and subgroups located on the new updated interface.

The second way of visual feedback provides that:
t) Each item is highlighted by suitable highlighting means provided with information regarding the number of selection to be done with the command sensor employed to select it.
u) An icon that allows to go back to previous group/subgroup is displayed during the sequence of scanning process and all the items belonging to groups/subgroups of previous levels are highlighted by said suitable highlighting means of different colour.
v) Once the selection is made, the scanning starts again from the subgroup currently highlighted, the items of which items will be highlighted, in turn, by suitable highlighting means provided with the indication of the number of selections to do diminished by one or from the group/subgroup of previous level if the corresponding icon is selected.
w) The previous steps t)-v) are repeated until the single items are reached which are highlighted by said further highlighting means that move in accordance with predefined times and sequences.
x) Once the target item is selected a corresponding action is performed and the interface is updated accordingly, the scanning process will start again from the groups and subgroups located on the new updated interface.

1. Apparatus for aided access to communication and/or writing, including means of processing of data and information, means of storage of said data and information, means of user interfacing and command sensors usable by people with severe motor disabilities.

2. Apparatus according to the claim 1 characterized in that said means of processing of data and information comprise a suitable control section based on at least a microprocessor.

3. Apparatus according to claim 2 characterized in that said means of processing of data and information comprise a personal computer.

4. Apparatus according to claims 1-3 characterized in that said means of user interfacing comprise means of data visualisation and input.

5. Apparatus according to claims 1-4 characterized in that said means of storage of said data and information comprise hard disks drives and flash memories.

6. Apparatus according to claims 1-5 characterized in that said command sensors comprise devices adapted to detect movements, chosen in the group comprising: buttons, pressure sensors, deformation sensors, puff sensor, myoelectric sensors, photoelectric sensors.

7. Method for aided access to communication and/or writing to be performed on an apparatus for aided access to communication and/or writing including means of processing of data and information, means of storage of said data and information, means of user interfacing and command sensors usable by people with severe motor disabilities characterized in that it comprises the following steps:
a) A user interface is displayed (20) on the visualization means of said apparatus.
b) A scanning is performed (21) of the groups and sub-groups of elements displayed on said user interface, said groups and sub-groups comprising progressively a lower number of items at each step, said items being grouped in accordance with their position and/or function, until a single item group is reached.
c) The target item is selected (22) through activation of a command sensor associated to said apparatus.
d) The action corresponding to the selected item is carried out (23) and said user interface is changed accordingly.
e) The above sequence of steps recurs starting from step b) until it is terminated by an external command.

8. Method according to the claim 7 characterized in that said step b) comprises the following steps:
l) The scanning of main groups is performed (41) until one of them is selected through the activation of a command sensor associated to said apparatus.
m) The scanning of subgroups is performed (42) until one of them is selected to reach single items, through the activation of a command sensor associated to said apparatus.
n) The scanning of single items is performed (43) until the target item is selected through the activation of a command sensor associated to said apparatus and the associated command/action is performed.

9. Method according to claims 7-8 characterized in that said step b) is carried through the following steps:
f) The Scanning States Management Module receives input from the user, changes its state, produces an event and sends it (31) to the Events Manager Module.
g) The Events Manager Module processes the event received and sends (32) the notifications of such changes to the Scanning Feedback Management Module.
h) The Scanning Feedback Management Module, after request of data for update to Scanning States Management Module, produces (33) the suitable feedback and then waits for further input.

10. Method according to claims 7-9 characterized in that said step d) is carried out through the following steps:
i) The Events Manager Module carries out a mapping of user input and actions performed and sends (34) notifications of state changes to the States Manager Module.
j) The States Manager Module, holding the current state, changes its own state and sends (35) the notifications of such changes to the Interface Manager Module.
k) The Interface Manager Module, after requesting data for updating to the States Manager Module, generates (36) a suitable interface and waits for further user input.

11. Method according to claims 7-10 characterized in that said scanning process of groups and subgroups according to step b) is carried out using a visual feedback mode performed according to the following steps:
o) Suitable highlighting means are moved on said visualization means in accordance with predefined times and sequences highlighting said groups while the items belonging to said groups are highlighted using further highlighting means.
p) An icon that allows to step back to the previous group/subgroup is displayed on said visualization means during scanning process allowing to go back to the scanning of groups/subgroups of the previous level.
q) After the selection performed through command sensor, the scanning starts again from the subgroup which is currently highlighted by said suitable highlighting means, the items comprised thereby being highlighted by said further highlighting means.
r) The previous steps p) and o) are repeated until the single items are reached, the scanning of said single items proceeding in accordance with predefined times and sequences, highlighted by said suitable highlighting means.
s) Once the target item is selected a corresponding action is performed and the interface is updated accordingly, the scanning process will start again from the groups and subgroups located on the new updated interface.

12. Method according to claim 11 characterized in that said suitable highlighting means comprise a coloured rectangle circumscribing said main groups and said further highlighting means comprise a coloured dot associated to the items of said main groups.

13. Method according to claims 7-10 characterized in that said scanning process of groups and subgroups according to step b) is carried out using a visual feedback mode performed according to the following steps:
t) Each item is highlighted by suitable highlighting means provided with information regarding the number of selection to be done with the command sensor employed to select it.
u) An icon that allows to go back to previous group/subgroup is displayed during the sequence of scanning process and all the items belonging to groups/subgroups of previous levels are highlighted by said suitable highlighting means of different colour.
v) Once the selection is made, the scanning starts again from the subgroup currently highlighted, the items of which items will be highlighted, in turn, by suitable highlighting means provided with the indication of the number of selections to do diminished by one or from the group/subgroup of previous level if the corresponding icon is selected.
w) The previous steps t)-v) are repeated until the single items are reached which are highlighted by said further highlighting means that move in accordance with predefined times and sequences.
x) Once the target item is selected a corresponding action is performed and the interface is updated accordingly, the scanning process will start again from the groups and subgroups located on the new updated interface.

14. Method according to claim 13 characterized in that said suitable highlighting means comprise a coloured dot.
